(19) United States
(12) Patent Application Publication
(10) Pub. No.: US 2019/0036261 A1
(43) Pub. Date: Jan. 31, 2019

(54) ONE-PIECE ELECTRICAL CONTACTS

(71) Applicant: ITT Manufacturing Enterprises LLC, Wilmington, DE (US)

(72) Inventor: Mario Cesar Gonzalez, Murrieta, CA (US)

(21) Appl. No.: 15/663,269

(22) Filed: Jul. 28, 2017

(51) Int. Cl. H01R 13/20; H01R 13/05; H01R 13/03; H01R 9/03; H01R 13/11

(52) U.S. Cl. CPC H01R 13/20; H01R 13/052; H01R 13/11; H01R 9/03; H01R 13/03

(57) ABSTRACT

Various electrical contacts are disclosed. The contact can comprise a one-piece component that is configured to engage with the lead on a wire. The contact can be formed from a sheet of material. The sheet can be formed into a hollow tube that is configured to receive the lead. The hollow tube can have a longitudinal seam and tines. The tines can extend radially inwardly from an end of the hollow tube into the interior of the hollow tube. The tines can engage with the lead to facilitate electrical communication between the contact and the lead.

### BACKGROUND

### Field

This disclosure relates to electrical contacts, such as formed and rolled electrical contacts having a unitary construction.

### Certain Related Art

Electrical connectors are devices that are used to join electrical circuits using a mechanical assembly. Signals and/or power can be provided across the connector from a source device to a receiving device. The connector can include contacts that convey the signals and/or power.

### Summary of Certain Features

Some electrical contacts are machined parts. This typically involves removing material (e.g., metal) from a workpiece in order to achieve a specific shape, such as with turning, milling, or other operations. For example, some contacts are produced using a CNC machine, lathe, etc. Machining can be time consuming and expensive. Moreover, because machining is a subtractive manufacturing process, it produces substantial waste (e.g., chips of removed material).

Some electrical contacts are molded parts. For example, liquid metal can be poured into a mold that contains a hollow cavity of the desired shape, and can be allowed to cool and solidify. However, molding can be difficult, time-consuming, and/or expensive for certain types of shapes. For example, small, thin-walled, hollow tubular shapes may be difficult to produce with a molding operation. Moreover, for such shapes, it can be difficult to achieve acceptable levels of precision and accuracy using molding operations alone, so secondary operations may be needed.

Various embodiments disclosed herein relate to electrical contacts that address one or more of the problems discussed above, or other problems. For example, some embodiments of this disclosure relate to contacts that are formed and rolled parts. For example, the contact can comprise a sheet of material that is formed (e.g., bent) and is rolled (e.g., wrapped) into a hollow tubular shape. This can be advantageous because such a process can be done rapidly and little or no material needs to be removed. Furthermore, the forming and rolling process can achieve high levels of precision and accuracy in the finished part.

In several embodiments, the contact comprises a one-piece component that is configured to engage with the lead (e.g., conductor) on a wire. The contact can be formed from a sheet of material. The sheet can be formed into a hollow tube that is configured to receive the lead. The hollow tube can have a longitudinal seam (e.g., gap). The hollow tube can have one or more tines. The tines can extend radially inwardly from an end of the hollow tube into the interior of the hollow tube. The tines can engage with the lead to facilitate electrical communication between the contact and the lead.

The foregoing summary is a high-level overview of certain features of the disclosed technology. The summary is illustrative only and is not intended to be limiting. Other aspects, features, and advantages of the devices and methods described in this application will become apparent in the teachings set forth below. No feature in this disclosure is essential or critical.

### BRIEF DESCRIPTION OF THE DRAWINGS

Various features and advantages of the devices and methods described herein will become apparent from the following description, taken in conjunction with the accompanying drawings. These drawings depict several embodiments in accordance with the disclosure. The drawings are not to be considered limiting. In the drawings, similar reference numbers or symbols typically identify similar components, unless context dictates otherwise.

FIG. 1 illustrates a side cross-sectional view of an electrical connector.

FIG. 2 illustrates a front perspective view of an electrical contact, which can be used in the connector of FIG. 1.

FIG. 3 illustrates a rear perspective view of the contact of FIG. 2.

FIG. 4 illustrates a top view of the contact of FIG. 2.

FIG. 5 illustrates a bottom view of the contact of FIG. 2.

FIG. 6 illustrates a right side view of the contact of FIG. 2, the left side view being a mirror image thereof.

FIG. 7 illustrates a front view of the contact of FIG. 2.

FIG. 8 illustrates a rear view of the contact of FIG. 2.

FIG. 9 illustrates a rear right side perspective cross-sectional view of the contact of FIG. 2.

FIG. 10 illustrates a side cross-sectional view along the line 10-10 of FIG. 5.

FIG. 11 illustrates a close-up of a portion of the contact of FIG. 10.

FIG. 12 illustrates a rear top perspective cross-sectional view of the contact of FIG. 2.

FIG. 13 illustrates a side cross-sectional view along the line 13-13 of FIG. 6.

FIG. 14 illustrates a close-up of a portion of the contact of FIG. 13.

FIGS. 15-19 illustrate top and side views of certain portions of a method of manufacturing a contact.

### DETAILED DESCRIPTION OF CERTAIN EMBODIMENTS

Various features and advantages of the electrical contacts described herein will become more fully apparent from the following description of the several specific embodiments illustrated in the figures. These embodiments are intended to illustrate the principles of this disclosure. However, this disclosure should not be limited to only the illustrated embodiments. The features of the illustrated embodiments can be modified, combined, removed, and/or substituted as will be apparent to those of ordinary skill in the art upon consideration of the principles disclosed herein.

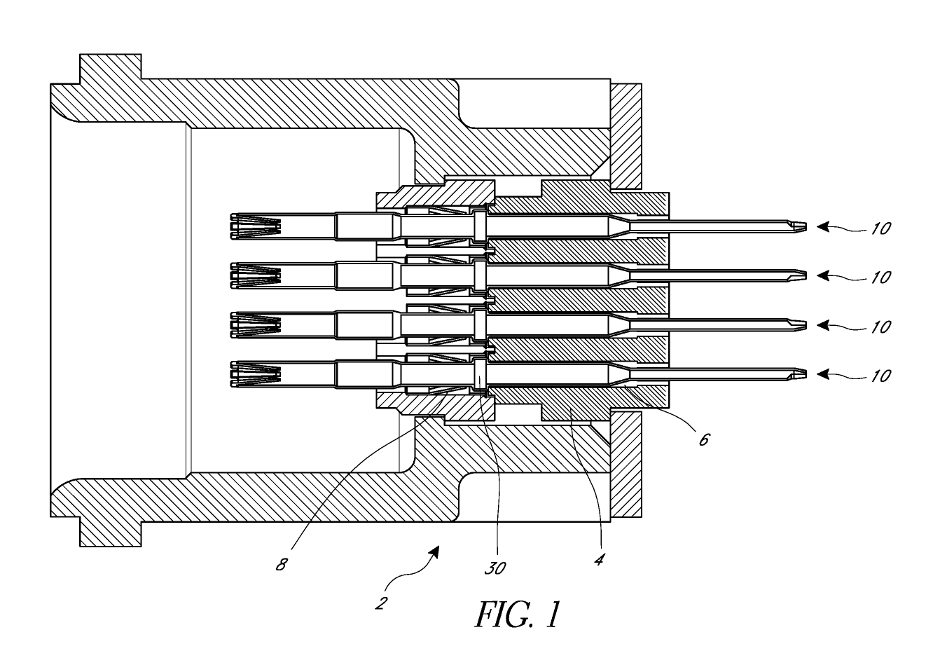

### Connector Overview (FIG. 1)

FIG. 1 illustrates an example electrical connector. As shown, the electrical connector 2 can include one or a plurality of electrical contacts 10. The electrical connector 2 can mate with a corresponding electrical connector, which can have corresponding electrical contacts. For example, the illustrated electrical connector 2 comprises a male connector, which can mate with a corresponding female connector. This can provide electrical communication between the respective contacts of the male and female connectors. The electrical connector 2 can have an inner section 4, which can comprise a dielectric material. The inner section can have passages 6 that the contacts 10 extend through. As shown, in some embodiments, proximal ends of the contacts 10 extend beyond an end of the passages 6. In some variants, the proximal ends of the contacts 10 terminate within the passages 6. The distal ends of the contacts 10 can couple with respective conductors. For example, the distal ends can each receive a lead on a wire.

The contacts 10 can include features to aid in securing the contacts 10 within the electrical connector 2. For example, as discussed in more detail below, the contacts 10 can have a shoulder 30. As shown, the shoulder 30 can engage with corresponding features of the connector 2, such as a corresponding shoulder of the inner section 4. In some embodiments, connector 2 includes fastening features, such as clips 8 that secure the contact 10 in place. For example, the clips 8 can present a physical interference with the shoulder 30, thereby inhibiting of preventing accidental removal of the contacts 10.

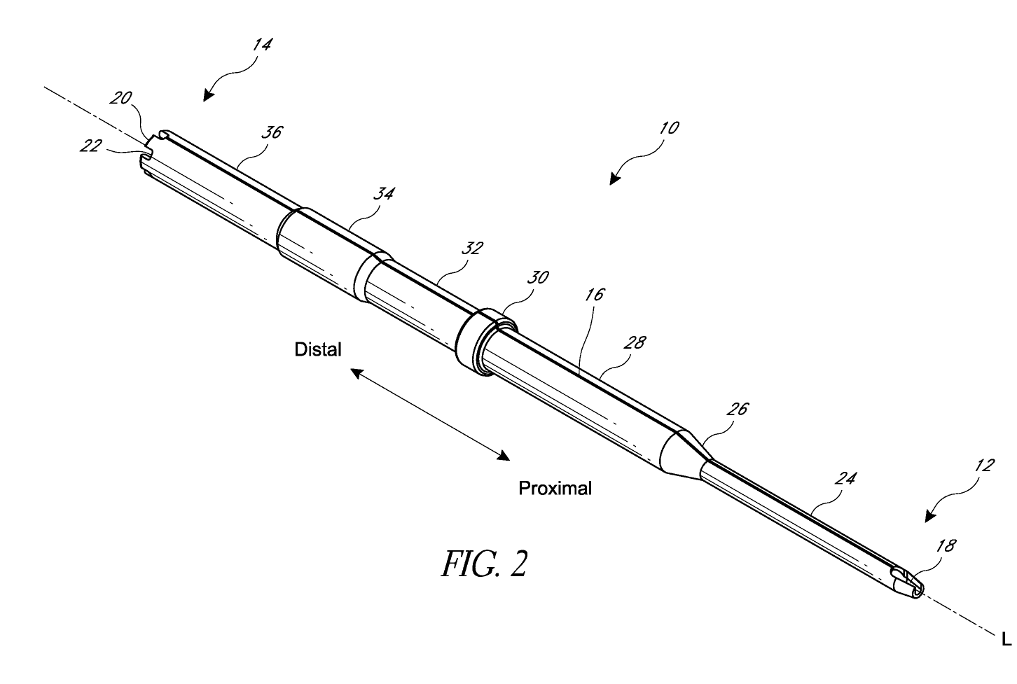

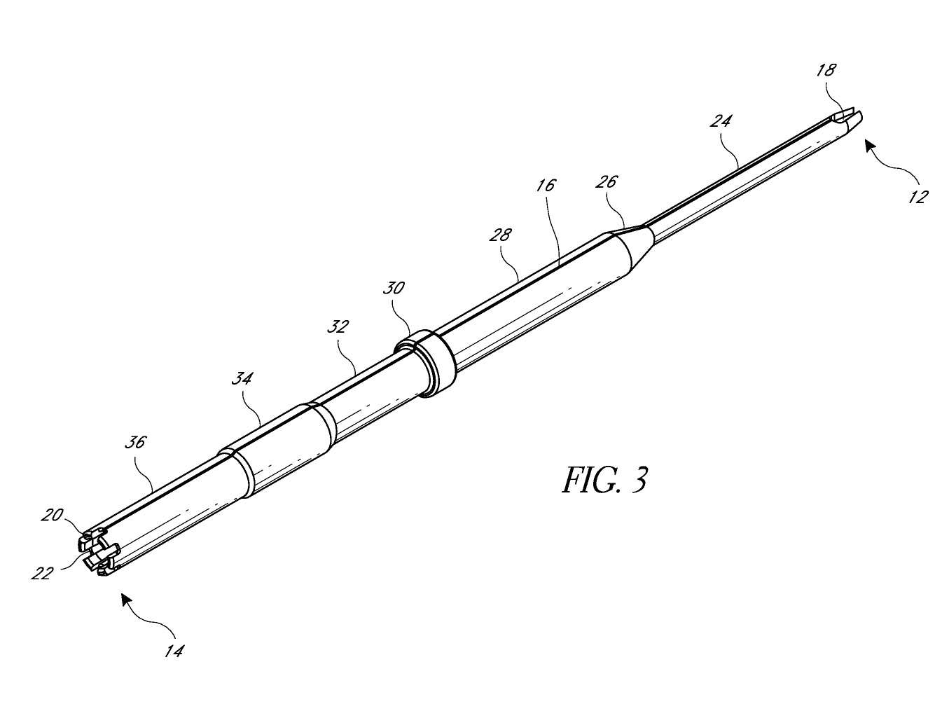

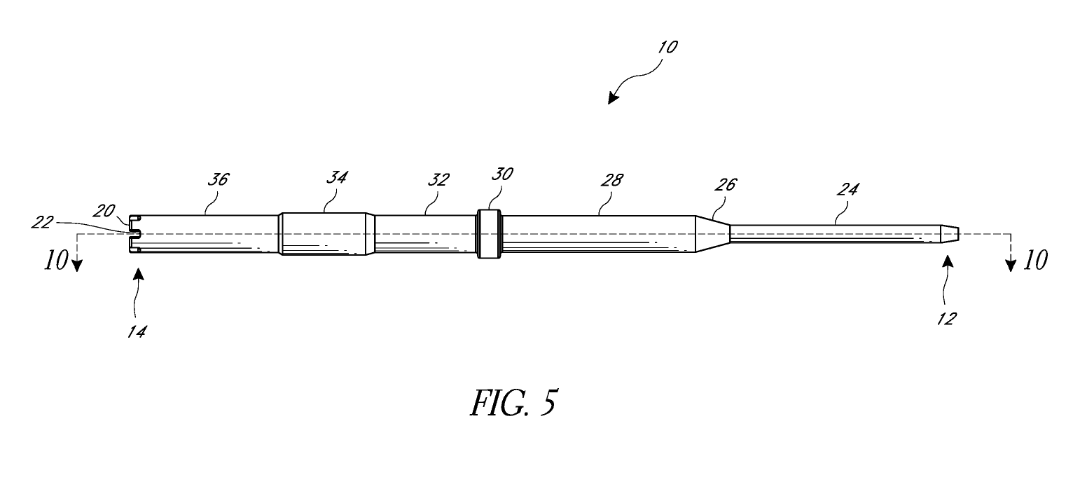

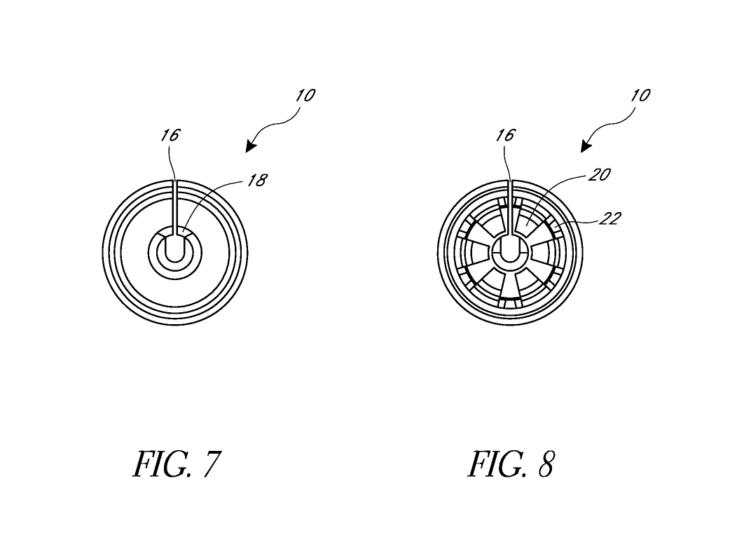

### Contact Overview (FIGS. 2-8)

FIGS. 2-8 illustrate an embodiment of the electrical contact 10. As shown, the contact 10 can comprise an elongate unit with a longitudinal axis L. The contact 10 can comprise a tubular member, such as a hollow pipe. The contact 10 has a proximal first end 12 and a distal second end 14. The ends 12, 14 can be joined by an intermediate portion of the contact 10. In various embodiments the contact 10 comprises an electrically conductive material, such as a metal. For example, the contact 10 can comprise steel, stainless steel, aluminum, copper, or other metals.

In various embodiments, the contact 10 has a unitary construction. For example, the contact 10 can be formed from a single sheet of material. The sheet can be generally planar. In certain embodiments, the contact 10 does not comprise multiple components that are coupled together. In some embodiments, the contact 10 is unitarily formed. In various embodiments, the contact is a one-piece component. A one-piece contact can avoid the need to obtain and connect multiple components, can increase reliability, and/or can reduce cost. In some embodiments, the contact 10 has a thin-walled construction. For example, the radial thickness of the wall (e.g., the thickness of the sheet) can be less than or equal to about: 0.50 mm, 0.25 mm, 0.15 mm, 0.10 mm, 0.05 mm, thicknesses between the aforementioned thicknesses, or other thicknesses. In some embodiments, the contact 10 is relatively small in size. For example, the contact 10 can have an outside diameter of less than or equal to about: 7 mm, 5 mm, 3 mm, 2 mm, 1 mm, diameters between the aforementioned diameters, or other diameters. In certain variants, the longitudinal length of the contact 10 is less than or equal to about: 60 mm, 50 mm, 40 mm, 25 mm, 15 mm, lengths between the aforementioned lengths, or other lengths.

As shown, the contact 10 can include a discontinuity, such as a longitudinal seam 16. The seam 16 can comprise a gap, opening, slot, or otherwise. The seam 16 can extend from the first end 12 to the second end 14. As shown, the seam 16 can be unbounded (e.g., open) on the longitudinal ends of the contact 10. In various embodiments, the seam 16 is formed during and/or as a consequence of the manufacturing of the contact 10. For example, in some embodiments, the contact 10 is formed by wrapping the lateral sides of a sheet of material around the longitudinal axis until the sides are adjacent each other, thereby forming the seam 16. The seam 16 can space apart the lateral sides and/or can be a space in which the lateral sides do not touch. In certain variants, the seam 16 comprises an overlap, such as a circumferential overlap of the lateral sides.

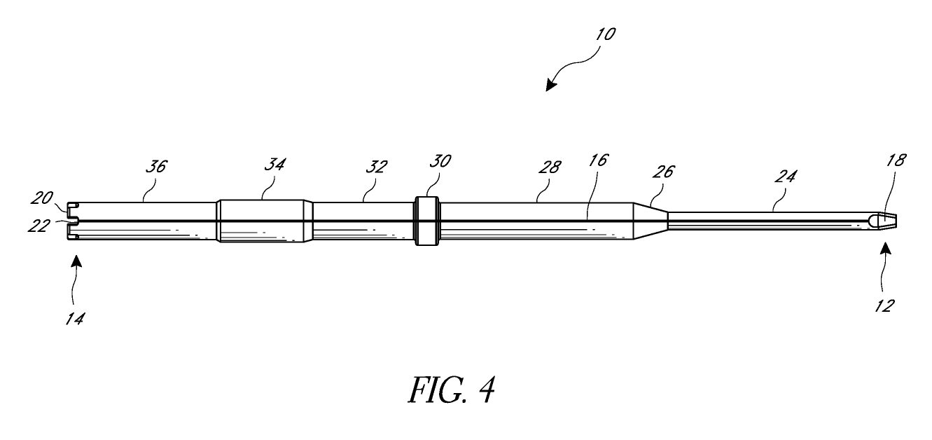

The first end 12 can be configured to engage with a mating contact. For example, as illustrated, the first end 12 can have a tapered engaging surface, such as on a terminal portion. The tapered engaging surface can aid in engaging (e.g., inserting) the first end 12 into the mating contact. In some embodiments, the first end 12 includes a notch 18. As shown, the notch 18 can comprise a generally scalloped shape. In certain implementations, the notch 18 facilitates manufacturing of the contact 10. In some embodiments, the notch 18 intersects and/or is aligned with the seam 16. The seam 16 can bisect the notch 18. In some implementations, the notch 18 has a generally teardrop or “U” shape when viewed from above (see FIG. 4). As shown, the notch 18 can extend distally beyond the tapered engaging surface.

In some embodiments, the second end 14 includes a plurality of projections 20 and/or recesses 22, as will be described in more detail below. In some implementations, the second end 14 is castellated. For example, as shown, the second end 14 can include multiple generally rectangular projections and/or indentations.

The contact 10 can include an elongated pin section 24. In some embodiments, the pin section 24 is configured to matingly engage with a corresponding socket section of a mating contact (not shown). The mating contact can be of the same or similar construction as the contact 10, but with the pin section 24 replaced with the socket section that is configured to receive a portion of the pin section 24.

As illustrated, the contact 10 can include a tapered portion 26, which is angled relative to the longitudinal axis. For example, the tapered portion 26 can be angled by at least about: 3°, 5°, 10°, 15°, 20°, 30°, angles between the aforementioned angles, or other angles. The tapered portion 26 can connect the pin section 24 with a first tubular portion 28. The diameter of the contact 10 can increase between proximal and distal ends of the tapered portion 26. For example, the tapered section 26 can increase the diameter from the diameter of the pin section 24 to the diameter of the first tubular portion 28. In some embodiments, the ratio of the diameter of the distal end of the tapered section 26 to the diameter of the proximal end of the tapered section 26 is at least about: 1.25, 1.5, 1.75, 2.0, ratios between the aforementioned ratios, or other ratios.

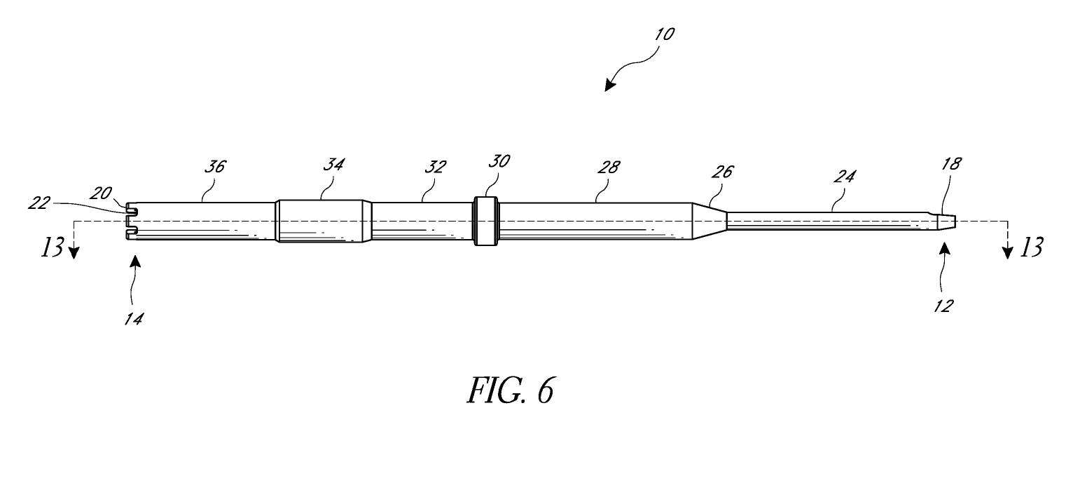

As previously mentioned, the contact 10 can include features configured to aid in securing the contact 10 in a mounting structure, such a connector body (see FIG. 1). For example, the contact 10 can include a flange, such as a shoulder 30. The shoulder 30 can be configured to engage with a corresponding recess in the mounting structure. This can secure and/or position the contact 10 in the mounting structure and/or can keep the contact 10 from disengaging from the connector. In several embodiments, the shoulder 30 extends radially outward relative to the first tubular portion 28. The shoulder 30 can comprise an annular protrusion on the contact 10. In some implementations, the shoulder 30 has a generally rectangular shape when viewed from the top (see FIG. 4) and/or the side (see FIG. 6). In some embodiments, the shoulder 30 is positioned near or at a longitudinal midpoint of the length of the contact. The shoulder 30 can have radiuses or chamfered ends. In various embodiments, the mounting structure is a dielectric material.

As shown, the contact 10 can include a second tubular portion 32. The second tubular portion 32 can have a diameter that is less than, approximately equal to, or greater than the diameter of the first tubular portion 28. In some embodiments, the second tubular portion 32 has a diameter that is less than or equal to the diameter of the shoulder 30. As shown, the length of the second tubular portion 32 can be less than the length of the first tubular portion 28. In some variants, the length of the second tubular portion 32 is approximately equal to or greater than the length of the first tubular portion 28. The length of the second tubular portion 32 can be greater than the length of the shoulder 30 and/or less than the length of the pin section 24.

In some embodiments, the contact 10 includes a stabilizer 34. The stabilizer 34 can be configured to engage with the mounting structure, such as with corresponding recesses in the mounting structure. This can facilitate securing the contact in the mounting structure. In certain implementations, the stabilizer 34 is configured to aid in keeping the contact 10 from moving excessively relative to the mounting structure. For example, the stabilizer 34 can contact (e.g., radially abut) with a portion of the connector 2 to inhibit or prevent skew of the contact 10 relative to the longitudinal axis of the connector 2. In some variants, the stabilizer 34 is configured to engage with the connector 2 to maintain the longitudinal axis of the contact 10 generally parallel to the longitudinal axis of the connector 2. In some embodiments, the length of the stabilizer 34 is greater than the length of the shoulder 30. The diameter of the stabilizer 34 can be less than or equal to the diameter of the shoulder 30. The length of the stabilizer 34 can be less than, approximately equal to, or greater than the length of the second body 32. The stabilizer 34 can be generally cylindrical. As illustrated, the stabilizer 34 can have tapered proximal and/or distal ends.

The contact 10 can include a third tubular portion 36. The third tubular portion 36 can have a diameter that is less than, approximately equal to, or greater than the diameter of the first tubular portion 28 and/or the second tubular portion 32. The third tubular portion 36 can have a longitudinal length that is greater than the second tubular portion 32 and/or stabilizer 34. In some embodiments, the length of the third tubular portion 36 is less than or equal to the length of the pin section 24 and/or first tubular portion 28. As illustrated, one or more of the tubular portions 28, 32, 36 can have an outside surface that is generally parallel to the longitudinal axis. In certain embodiments, one or more of the tubular portions 28, 32, 36 has a generally cylindrical shape.

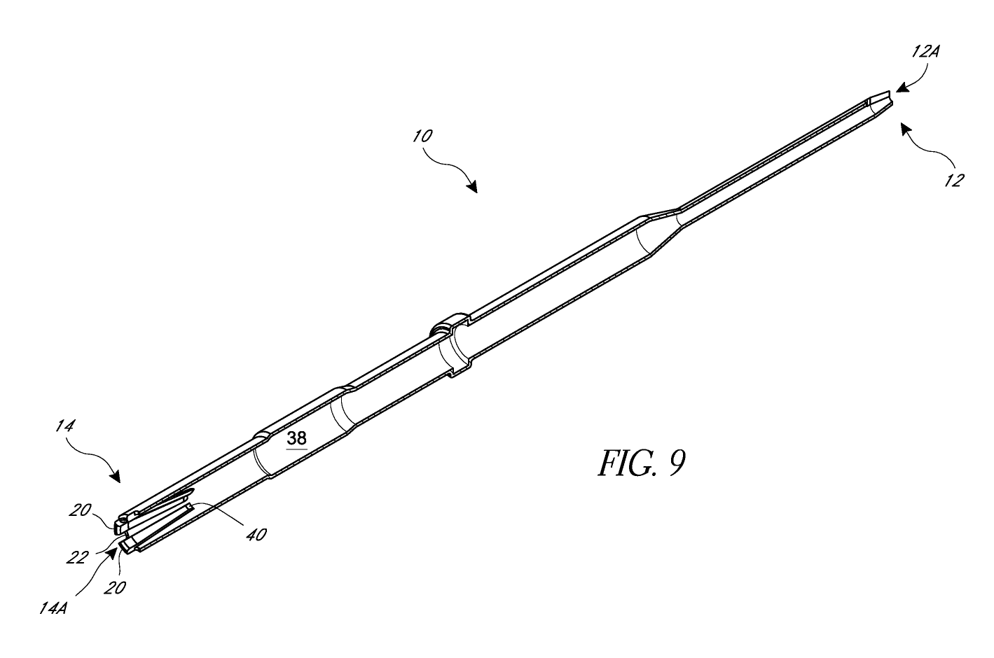

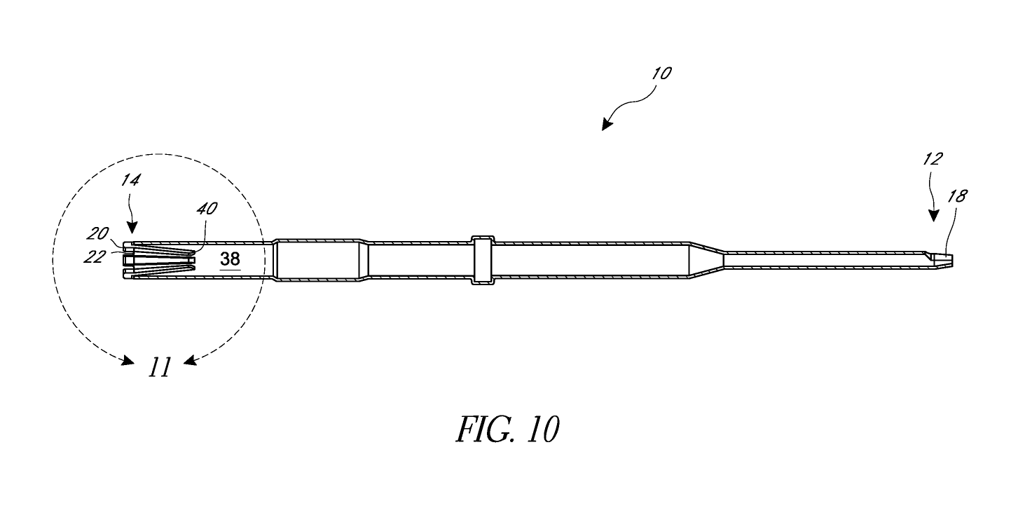

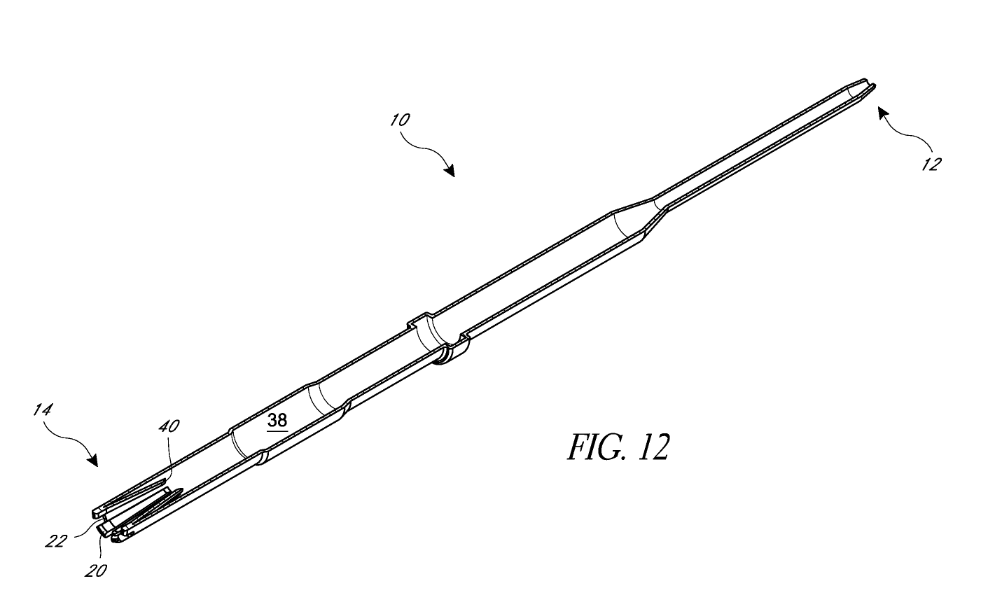

### Engaging Members (FIGS. 8-13)

As mentioned above, the contact 10 can be configured to facilitate electrical connection with a conductor, such as a wire mated with the contact 10. As shown in FIGS. 8-13, the second end 14 of the contact 10 can include one or more connection facilitating members, such as tines 40. Certain embodiments have 1, 2, 3, 4, 5, 6, 7, 8, or more tines 40. The tines 40 can extend inside a passage 38 in the contact 10. The passage 38 can extend between the first and second ends 12, 14. In certain implementations, the passage 38 is in fluid communication with apertures 12A, 14A at the terminus of the first and second ends 12, 14 and/or with the seam 16. In some embodiments, the tines 40 extend longitudinally, such as substantially parallel to the longitudinal axis L or at an acute angle relative to the longitudinal axis L. In various embodiments, the tines 40 can engage (e.g., abut) a conductor received in the second end 14. The engagement between the tines 40 and the conductor can provide a dependable electrical connection between the contact 10 and the conductor. As illustrated, in some embodiments, the tines 40 can have rounded or chamfered proximal ends 42. In various embodiments, the tines 40 comprise cantilevered arms. The cantilevered arms can be connected with the second end 14 and/or the projections 20. In some implementations, the tines 40 have a substantially equal longitudinal length.

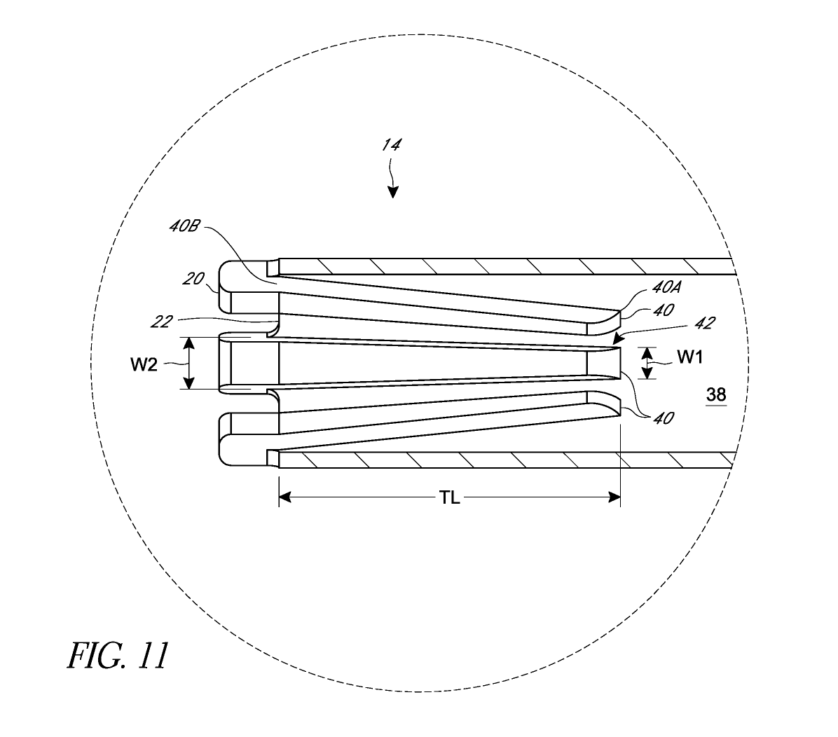

In some embodiments, the tines 40 have a tapered shape. For example, the tines 40 can taper (e.g., narrow) longitudinally, such as from the second end 14 in the direction toward the first end 12. As shown in FIG. 11, the tines 40 taper from a second end 40B to a first end 40A. The first end 40A can have a width W1 and the second end 40B can have a width W2. In some embodiments, W1 is less than or equal to W2. For example, the ratio of W1 to W2 can be less than or equal to about: 0.99, 0.95, 0.90, 0.85, 0.80, 0.75 ratios between the aforementioned ratios or other ratios. As shown, in some embodiments, the first end 40A is cantilevered and/or is a free end (e.g., is spaced apart from and/or not connected to another structure of the contact). In some implementations, the second end 40B is connected to the third tubular portion 36 and/or to one of the projections 20.

As shown, the tines 40 can have a tine length TL. The tine length TL can be greater than or equal to the outside diameter of the contact 10, such as the outside diameter of the third tubular portion 36. In some embodiments, the ratio of the tine length TL to the outside diameter of the third tubular portion 36 is at least about: 1.2, 1.4, 1.6, 1.8, 2.0, ratios between the aforementioned ratios, or other ratios.

As mentioned above, the second end 14 can be castellated. For example, as illustrated, the projections 20 and recesses 22 can form castellations on the second end 14, such as the projections 20 forming merlons and the recesses 22 forming embrasures. The projections 20 can extend distally on the second end 14. As shown in FIG. 11, the projections 20 and/or recesses 22 can have a generally rectangular shape, though other shapes are contemplated as well, such as triangular, trapezoidal, or otherwise,

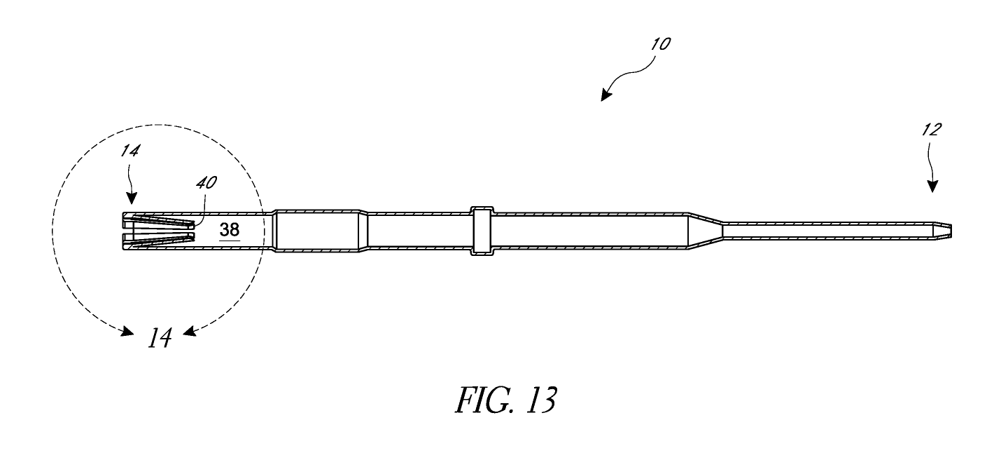

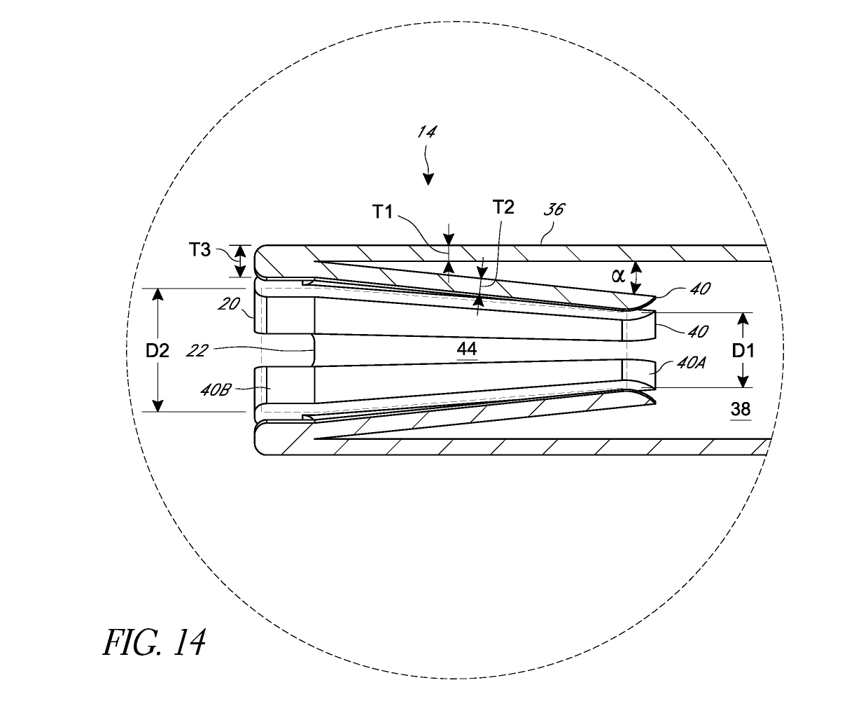

In various implementations, the tines 40 are angled relative to the longitudinal axis L and/or the third tubular portion 36 of the contact 10. For example, as shown in FIG. 14, the tines 40 can be positioned at an angle α relative to the longitudinal axis L and/or the third tubular portion 36. In some embodiments, the angle α is at least about: 3°, 5°, 10°, 15°, 20°, 30°, angles between the aforementioned angles, or other angles.

As illustrated, the third tubular portion 36 can have a thickness T1, the tines 40 can have a thickness T2, and the projections 20 can have a thickness T3. The thickness T3 can be greater than the thickness T1 and/or the thickness T2. For example, the thickness T3 can be at least about twice the thickness T1 and/or the thickness T2. In some embodiments, the thicknesses T1 is greater than or about equal to the thickness T2.

In some embodiments, the tines 40 bound a receiving space (indicated by the dashed lines in FIG. 14). The receiving space can be configured to receive the conductor, such as the lead on a wire. In various embodiments, a proximal end of the receiving space is longitudinally aligned with the first end 40A of the tines 40. As shown, the proximal end of the receiving space can have a diameter D1 that is less than the diameter D2 of a distal end of the receiving space. For example, the ratio of D1 to D2 can be less than or equal to about: 0.9, 0.8, 0.7, 0.6, 0.5, 0.4, ratios between the aforementioned ratios, or other ratios. The tines 40 can be configured such that the diameter D1 is less than the outside diameter of the conductor inserted into the receiving space.

In various embodiments, during insertion of the conductor into the receiving space, the tines 40 are deflected, such as being pushed radially outward. This can provide positive engagement (e.g., physical abutment) between the contact 10 and the conductor, which can increase the likelihood of providing and maintaining reliable electrical connectivity between the conductor and the contact 10. Reliable connectivity can be particularly important in certain applications, such as aerospace applications. In some implementations, the tines 40 are deflected into a position that is substantially parallel with the longitudinal axis. In various embodiments, the tines 40 are resilient. For example, in some implementations, in response to the conductor being removed from the receiving space, the tines 40 return to substantially the portion they were in before the conductor was inserted into the receiving space.

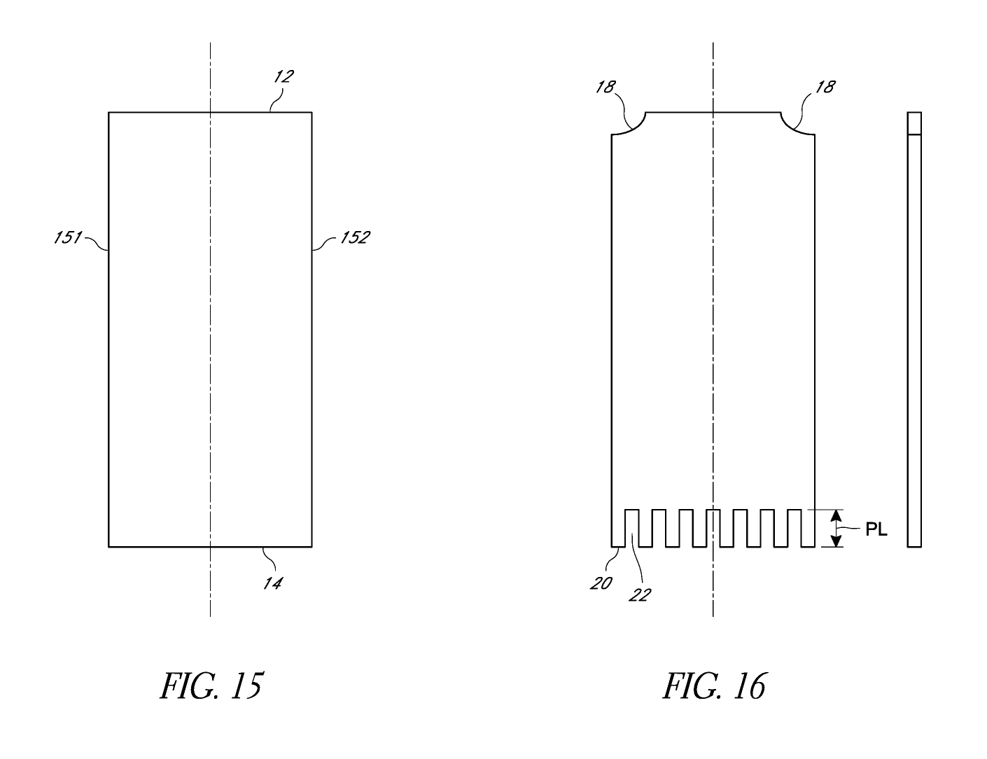

### Methods of Manufacturing (FIGS. 15-19)

FIGS. 15-19 illustrate an example method of manufacturing a contact, such as the contact 10. FIG. 15 illustrates an example of a sheet of material, such as a sheet of a metal. The sheet can have a first end 12, second end 14, first lateral side 151, and second lateral side 152. As illustrated, the sheet can be rectangular in shape, though other shapes are contemplated as well such as square, elliptical or otherwise.

FIG. 16 illustrates the sheet of FIG. 15 after a forming process. The forming process can include removing notches 18 from corners of the sheets. The forming process can include removing portions of the second end of the sheet, such as to form projections 20 and recesses 22. In some embodiments, the projections 20 and/or recesses 22 are formed by a stamping or cutting operation. As shown, the projections 20 can have a projection length PL.

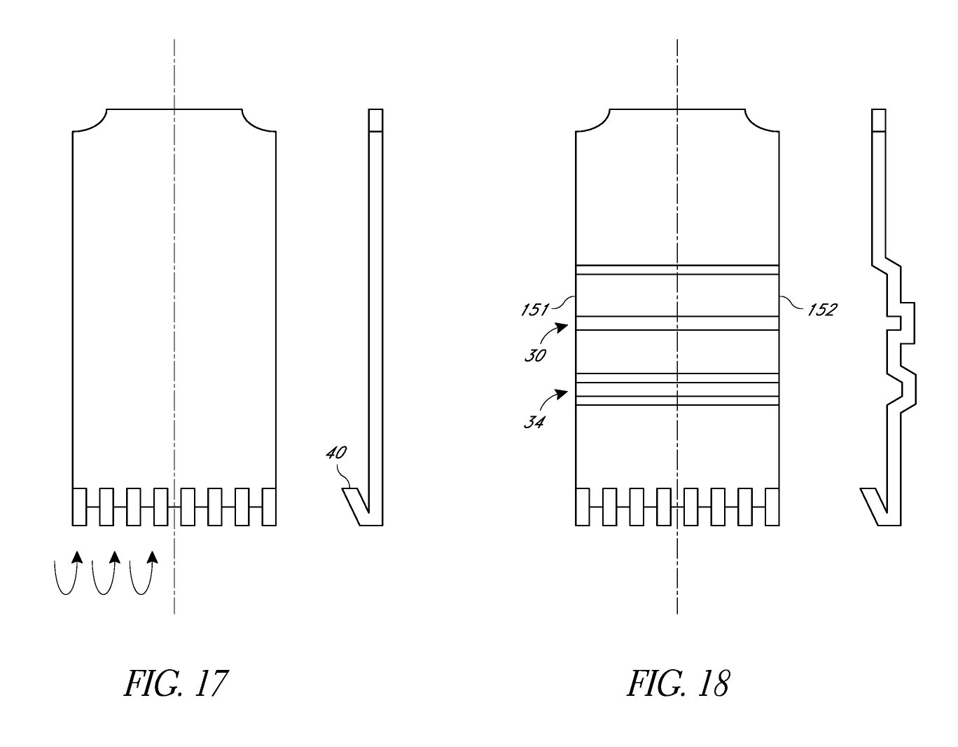

FIG. 17 illustrates the sheet of FIG. 16 after a bending operation. In the bending operation the projections 20 are deformed. For example, the projections 20 can be folded over a portion of the sheet to form the tines 40. In the embodiment of FIG. 16, the tines 40 are folded toward the first end of the sheet. The tines 40 can be folded at least about: 90°, 120°, 140°, 150°, 160°, 170°, angles between the aforementioned angles, or other angles. In some embodiments, the tines 40 are folded at about the midpoint of the projection length PL.

FIG. 18 illustrates the sheet of FIG. 17 after a further forming operation. This can include forming the taper 26, shoulder 30, and/or the stabilizer 34 and in the sheet. In some embodiments, the sheet is bent with a break to form the taper 26, shoulder 30, and/or the stabilizer 34.

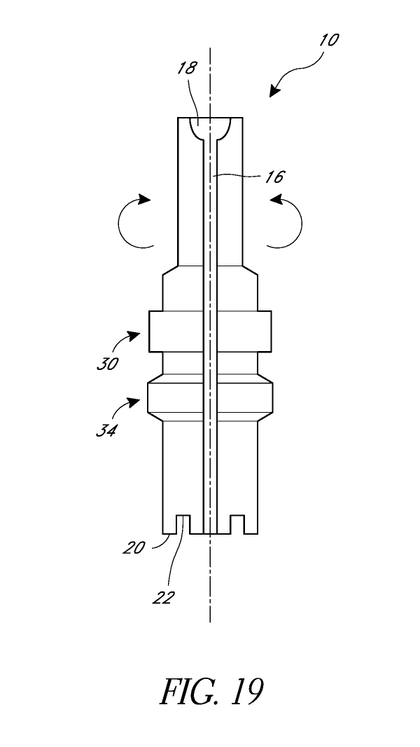

FIG. 19 illustrates the sheet of FIG. 18 formed into a hollow tube. In various embodiments, the method includes wrapping and/or rolling the lateral sides 151, 152, such as about the longitudinal axis L. In some implementations, the sheet is wrapped around a mandrel or other shaping device to form the tubular contact 10. In the embodiment shown in FIG. 15, the method can include wrapping the lateral sides 151, 152 in a direction perpendicular to the longitudinal axis. For example, as shown in FIG. 19, the method can include wrapping the lateral sides 151, 152 out of the page such that the lateral sides 151, 152 wrap around and are positioned adjacent one another. The lateral sides 151, 152 can be spaced apart from each other by the seam 16. In some variants, the travel sides 151, 152 overlap circumferentially. The wrapping of the lateral sides 151, 152 can form the contact 10.

### Certain Terminology

Although various electrical contacts have been disclosed in the context of certain embodiments and examples, this disclosure extends beyond the specifically disclosed embodiments to other alternative embodiments and/or uses of the embodiments and certain modifications and equivalents thereof. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Certain features that are described in this disclosure in the context of separate implementations or embodiments can also be implemented in combination in a single implementation or embodiment. Conversely, various features that are described in the context of a single implementation or embodiment can also be implemented in multiple implementations or embodiments separately or in any suitable subcombination. Moreover, although features may be described above as acting in certain combinations, one or more features from a claimed combination can, in some cases, be excised from the combination, and the combination may be claimed as any subcombination or variation of any subcombination.

Terms of orientation used herein, such as “top,” “bottom,” “proximal,” “distal,” “longitudinal,” “lateral,” and “end,” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Some embodiments have been described in connection with the accompanying drawings. The figures are to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

### SUMMARY

Various embodiments and examples of electrical contacts have been disclosed. Although these have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow.

The following is claimed:

1. An elongate hollow one-piece electrical contact that extends a longitudinal axis, the electrical contact comprising:
a proximal first end that comprises a tapered engaging surface, the tapered engaging surface configured to engage with a mating electrical connector;
a distal second end opposite the proximal first end;
an intermediate portion that connects the proximal first end and the distal second end;
an inner passage that extends longitudinally between the proximal first end and the distal second end;
a gap that extends longitudinally between the proximal first end and the distal second end; and
a plurality of tines on the distal second end, the tines extending proximally and into the inner passage, the tines bounding a receiving space, the receiving space configured to receive a conductor to provide electrical communication between the conductor and the contact;
wherein the electrical contact is a single component and is formed from a sheet of material.

2. The electrical contact of claim 1, wherein the plurality of tines are configured to resiliently deflect in response to insertion of the conductor.

3. The electrical contact of claim 1, wherein each of the plurality of tines are at an angle α with respect to the longitudinal axis, the angle α being less than or equal to 20°.

4. The electrical contact of claim 1, wherein the intermediate portion comprises a radially-outwardly extending flange.

5. The electrical contact of claim 1, wherein the proximal first end further comprises a U-shaped notch.

6. The electrical contact of claim 1, wherein the distal second end comprises a plurality of projections and recesses.

7. The electrical contact of claim 1, wherein the distal second end is castellated.

8. A method of manufacturing an electrical contact, the method comprising:
obtaining a sheet of material, the sheet having a first end, a second end opposite the first end, a first lateral sidewall, and a second lateral sidewall opposite the first lateral sidewall;
forming projections on the second end of the sheet of material;
bending the projections over a portion of the sheet of material and toward the first end;
forming a flange in an intermediate portion of the sheet of material; and
wrapping the first lateral sidewall and the second lateral sidewall toward each other, thereby forming a hollow tubular contact with the projections on the radial inside of the contact.

9. The method of claim 8, further comprising forming notches on the first end of the sheet of material.

10. The method of claim 8, further comprising maintaining a gap between the first lateral sidewall and the second lateral sidewall.

11. The method of claim 8, wherein bending the projections over a portion of the sheet of material comprises bending the projections such that the projections extend at an angle α with respect to the plane of the sheet of material, the angle α being less than or equal to 20°.

12. The method of claim 8, wherein the method does not include machining the contact with a mill or lathe.

13. The method of claim 8, wherein forming the projections comprises forming the projections with a length L, and wherein bending the projections comprises bending the projections at approximately the midpoint of the length L.

14. The method of claim 8, wherein forming the projections comprises cutting recesses on the second end of the sheet of material.

15. The method of claim 8, wherein wrapping the first lateral sidewall and the second lateral sidewall toward each other comprises rolling the sheet of material around a mandrel.
